(19) United States
(12) Patent Application Publication
(10) Pub. No.: US 2007/0005776 A1
(43) Pub. Date: Jan. 4, 2007

(54) METHOD AND SYSTEM TO USE A TELEPHONE EXTENSION NUMBER TO IDENTIFY A SESSION, SUCH AS AN INTERNET SESSION THAT BROWSES REAL ESTATE INFORMATION

(75) Inventors: Glen L. Hansen, Redmond, WA (US); Keith M. Hansen, Woodinville, WA (US); Lonnie C. M. Kyser, Kenmore, WA (US)

Correspondence Address: SEED INTELLECTUAL PROPERTY LAW GROUP PLLC, 701 FIFTH AVE, SUITE 5400, SEATTLE, WA, 98104, US

(73) Assignee: IRONTRACK TECHNOLOGY, INC., Bellevue, WA (US)

(21) Appl. No.: 11/428,206

(22) Filed: Jun. 30, 2006

Related U.S. Application Data
(60) Provisional application No. 60/695,838, filed on Jun. 30, 2005.

(51) Int. Cl. G06F 15/16

(52) U.S. Cl. 709/227

(57) ABSTRACT

One or more session identifiers (IDs) are used to identify a consumer's browsing session through a network, such as an Internet browsing session for real estate information. The session ID(s) and related browsing data are stored, thereby tracking and capturing data pertaining to the consumer and/or the consumer's preferences. When the consumer views details of an item of interest (such as a home), details about the home are captured and stored, and a telephone number and telephone extension number are presented to the consumer. The telephone extension number is associated with the session ID(s). When the consumer dials the telephone number and provides the telephone extension number to make further inquiries about the home, the telephone call is directed to a call center, and an operator at the call center uses the telephone extension number as input to a lead tracking computing system that uses the telephone extension number to locate the associated session ID and to access the corresponding browsing data. The lead tracking computing system generates a script for use by the operator in conducting a dialog with the consumer to obtain additional information, thereby facilitating service of the consumer. The consumer's inquiry is a lead that can then be provided to a lead distribution system.

### CROSS-REFERENCE TO RELATED APPLICATION

The present application claims the benefit under 35 U.S.C. § 119(e) of U.S. Provisional Patent Application Ser. No. 60/695,838, entitled “METHOD AND SYSTEM TO USE A TELEPHONE EXTENSION NUMBER TO IDENTIFY A SESSION, SUCH AS AN INTERNET SESSION THAT BROWSES REAL ESTATE INFORMATION,” filed Jun. 30, 2005, and incorporated herein by reference in its entirety.

### TECHNICAL FIELD

The present disclosure generally relates to tracking browsing behavior, and in particular but not exclusively, relates to tracking browsing behavior, such as Internet browsing of real estate information, so as to better service subsequent consumer inquiries.

### BACKGROUND INFORMATION

The Internet allows the providers of goods and/or services the ability to reach potential consumers directly in unprecedented ways. Conversely, the Internet provides potential consumers new ways to research and shop for goods and/or services, and to find providers of such goods and/or services. This new medium gives rise to new consumer behaviors, resulting in new demands upon the providers who serve such consumers.

One example of the many possible examples may be instructive.

The consumer may, for example, be brought into the “door” of one provider (e.g., the provider's website or webpage), then led to the “door” of another provider (e.g., via a link to a second provider's website or webpage), and then led to the “door” of yet another provider, while all the time maintaining complete freedom to “browse” and research. In this example, the originator of the consumer inquiry (i.e., lead) will in most cases not be the service provider of the lead or the ultimate provider of the purchased goods and/or services.

When a potential consumer is interested in more information on a particular good and/or service, the consumer may desire immediate assistance or may request assistance at some later time. The consumer commonly expects more knowledgeable assistance when they indicate they are ready for help and/or more information.

In order for businesses to keep pace with the demands of the consumer, businesses must adapt or evolve the way in which they conduct business. Specifically, businesses must change the way they obtain, distribute, and manage their consumer inquiries.

One way these demands can be met is through the creation of new business relationships by the providers of goods and/or services. One of the many possible examples of such a relationship is a group of real estate companies, or offices, and/or agents affiliating themselves into a network of other real estate companies, or offices, and/or agents to combine their collective resources and people, to the mutual benefit of each other. The affiliation of these third party entities within a network is synergistic for these entities.

Another way these demands can be met is through the creation of new people and financial processes used by the providers of goods and/or services to capture revenue from these consumer inquiries. As an example, currently, the multi-billion dollar real estate industry is experiencing revolutionary change. The use of the Internet, and particularly the World Wide Web portion of the Internet, as a shopping tool for home buyers (consumers) is exploding. According to statistics from the National Association of Realtors® (NAR), 38% of home buyers used the Internet as a research tool just a few years ago; while today 72% of home buyers use the Internet as a research tool. Home buyers who do not use the Internet look at an average of 18 to 20 homes with an Agent before purchasing, while home buyers who use the Internet look at an average of 6 to 7 homes with an Agent before purchasing. Home buyers who use the Internet expect convenience in searching for homes, and researching schools, communities and areas. Home buyers who use the Internet also demand a fast and professional response when they are ready to look at a home. The providers that adapt to the consumer trends such examples represent, will be those who will prosper and grow in this new market place. Such adaptation must include serving the changes in consumer behavior and the naturally resulting needs.

However, current systems that use the Internet to service customer inquiries often provide unsatisfactory and/or inefficient service. For example, a consumer typically accesses and browses website or webpage of a real estate company to search for homes of interest, such as homes located in a certain city or neighborhood, homes of a particular size or style, number of bedrooms, price range, or other criteria that consumers usually consider when shopping for a home. One technique to perform the browsing is to have the consumer navigate through categorical listings of homes, until homes of interest are located.

For instance, the website or webpage may organize listings according to a broad-to-specific hierarchical arrangement (e.g., using criteria such as state, city, neighborhood, price, square feet, number of bedrooms, etc.) or other suitable arrangement of home listings. The consumer can also often enter or otherwise specify such criteria in search fields provided by the website or webpage, and then initiate a search through listings using the specified search criteria.

The website or webpage then provides search results or otherwise provides information for the homes of interest to the consumer, which may include a telephone number or other contact information for the real estate company and/or real estate agent that is selling the home. The consumer can thereafter contact the real estate company and/or the real estate agent to obtain additional detailed information or to otherwise further pursue the possibility of purchasing the home.

However, when the consumer contacts the real estate agent, the consumer often needs to identify and describe the particular home to the agent, so that the agent knows which home is the subject of the consumer's inquiry. To identify the home, the consumer can verbally convey the multiple listing service (MLS) number, address, physical description, or other identification information to the agent. Thereafter, the agent can search records to provide the additional detailed information to the consumer.

This verbal conveyance of identification information to the agent is inefficient because the agent does not immediately know which home is the subject of the inquiry when the consumer calls on the telephone—the agent can only obtain this information after the consumer calls and has identified the home of interest to the agent. Moreover, the consumer often has to verbally repeat the information that was entered or selected via the website or webpage, such as city, neighborhood, address, or other identification information for the home. This repetitive conveyance of information can cause the consumer to become discouraged or to lose interest, particularly if significant time is used by the agent while on the telephone to look up the requested information, or if the agent has to tell the consumer, “I do not have the information in front of me right now. Let me look up the information and get back to you later.” The consumer may become frustrated with the agent and contact some other agent with better responsiveness, thereby depriving the original agent of a transaction opportunity. Moreover when the consumer contacts the other agent, the original agent is deprived of opportunities to present other homes that may be of potential interest to the consumer, if the particular home that is the subject of the original inquiry is no longer available.

### BRIEF SUMMARY OF THE DISCLOSURE

One aspect provides a method for a computer network. The method includes assigning a session identifier (ID) to a browsing session of a consumer of real estate. Browsing data associated with the browsing session of the consumer is stored. The session ID is associated with a representation of a telephone extension number that is presented to the consumer. In response to use of the telephone extension number by the consumer, at least some of the stored browsing data is retrieved.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of a networked environment in which at least one example embodiment may operate.

FIG. 2 is a functional block diagram of a computing system suitable for use in the networked environment of FIG. 1, according to one illustrated embodiment.

FIG. 3 is a flow diagram showing a high level method of facilitating lead referral, and distributing leads according to one illustrated embodiment.

FIG. 4 is a diagram showing example navigation through web sites and/or web pages during one or more sessions, with a telephone extension number being used to identify such session(s) according to one embodiment.

FIG. 5 is a flow diagram of a method to use the telephone extension number to identify one or more browsing sessions according to one embodiment.

FIG. 6 illustrates association of a session ID to a telephone extension number and storage of session IDs and associated browsing data according to an embodiment.

### DETAILED DESCRIPTION

In the following description, certain specific details are set forth in order to provide a thorough understanding of various embodiments. However, one skilled in the relevant art will recognize that the embodiments may be practiced without one or more of these specific details, or with other methods, components, materials, etc. In other instances, well-known structures associated with networks, servers, clients, databases and computing systems have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

The headings provided herein are for convenience only and do not interpret the scope or meaning of the claimed invention.

As an overview, one or more session identifiers (IDs) is used to identify a consumer's browsing session through a network, such as an Internet browsing session for real estate information. The session ID(s) and related browsing data are stored, thereby tracking and capturing data pertaining to the consumer and/or the consumer's preferences. When the consumer views details of an item of interest (such as a home), details about the home are captured and stored, and a telephone number and telephone extension number are presented to the consumer. The telephone extension number is associated with the session ID(s). When the consumer dials the telephone number, the telephone call is directed to a call center, and the consumer provides the telephone extension number, if available, to an operator at the call center. The operator at the call center uses the telephone extension number as an input into a tracking computing system. The tracking computing system generates the appropriate dialog for the operator at the call center to follow in order to solicit additional information to establish the lead. When the consumer's inquiry is established as a lead, the lead can then be provided to a lead distribution system by the tracking computing system. In an embodiment, data from the consumer's browsing session and/or data associated with the distribution of the lead can be tracked so as to properly reward the entity or entities who originated the lead or who should otherwise be properly compensated for a favorable outcome of a transaction with the consumer.

In one embodiment, it is noted that the call center does not act like a conventional customer service center. The operators in this embodiment are limited to asking questions that are generated by the tracking computing system. For example, operators cannot (for regulatory reasons in one embodiment) answer any questions about the property in question. Dialogs with the consumer are generated by the tracking computing system based on consumer input and/or other consumer data that has been obtained.

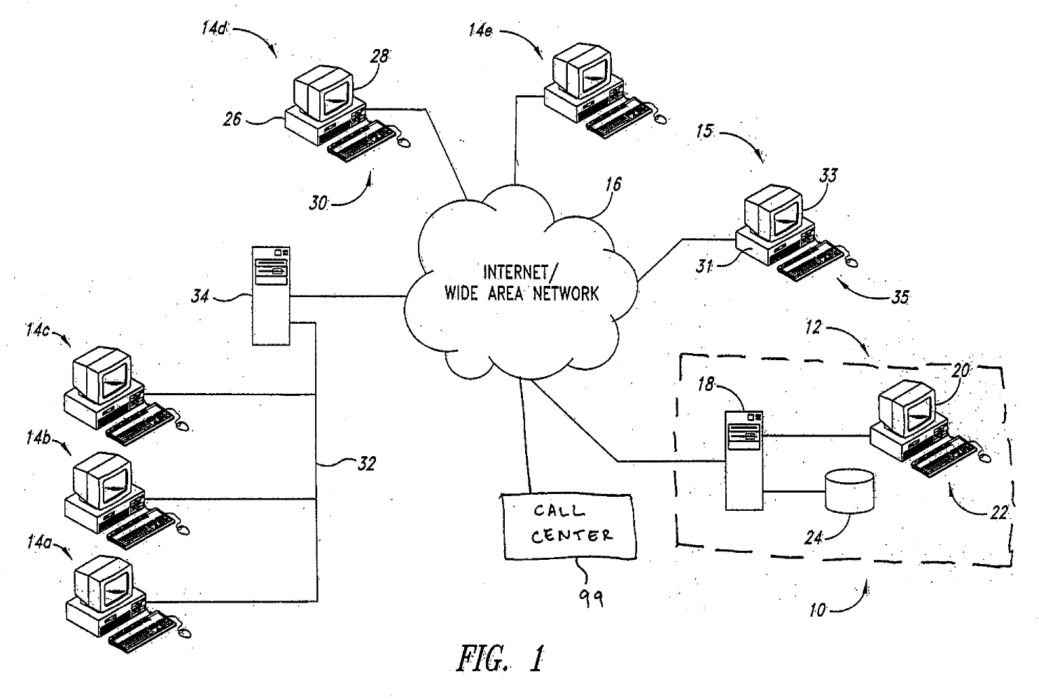

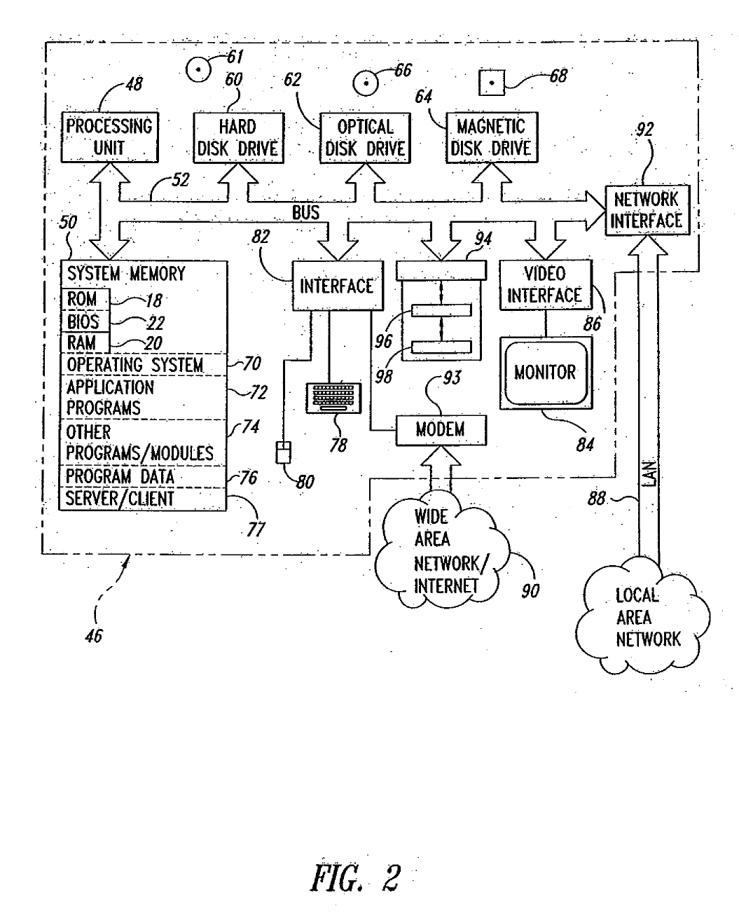

FIGS. 1 and 2, and the following discussion, provide a brief, general description of a suitable computing environment in which embodiments may be implemented. Although not required, embodiments will be described in the general context of computer-executable instructions, such as program application modules, objects, or macros being executed by a personal computer. Those skilled in the relevant art will appreciate that the embodiments can be practiced with other computing system configurations, including handheld devices, multiprocessor systems, microprocessor-based or programmable consumer electronics, network PCs, minicomputers, mainframe computers, and the like. Embodiments can be practiced in distributed computing environments where tasks or modules are performed by remote processing devices, which are linked through a communications network. In a distributed computing environment, program modules may be located in both local and remote memory storage devices.

In particular, FIG. 1 shows a networked environment 10 comprising a tracking computing system 12, and a number of third party computing systems 14a-14e, and a consumer computing system 15, all communicatively coupled via a Wide Area Network (WAN) such as the Internet 16. While represented as the Internet 16, the WAN may take the form of one or more extranets or intranets, or other types of networks, and can employ any of a variety of network architectures.

As described in more detail below, the tracking computing system 12 may take the form of a computer such as a server computer 18, and may optionally include a monitor 20 and one or more user input devices such as a keyboard, keypad, mouse, trackball, digitizing tablet 22, and/or touch screen display. The tracking computing system 12 may also include one or more data storage devices 24 storing one or more databases of information. While illustrated as being external to a housing of the server computer 18, one or more of the data storage devices 24 may be located internally in the housing of the server computer 18.

In an embodiment, all or parts of the tracking computing system 12 can be accessed by a call center 99, through the Internet 16 or some other suitable communication network. In an embodiment, the call center 99 can comprise a company and/or facility (e.g., fully automated or at least partially staffed by human operators) that receives consumer inquiries (e.g., leads) that are communicated via a telephone number and telephone extension number presented on a web page (such as a web page of an affiliated real estate company); that provides information (e.g., a telephone extension number) associated with the consumer inquiry into the tracking computing system 12; and/or that uses scripts provided by the tracking computing system 12 to obtain additional information from the consumer so that the tracking computing system 12 can decide how to process the consumer inquiry, including broadcasting the lead into a lead distribution system. In an alternative embodiment, the call center 99 performs some initial telephonic or other pre-screening of the lead, and then broadcasts the lead to agents or otherwise deals with the lead.

In an embodiment that will be described in further detail below, the tracking computing system 12 uses the telephone extension number to identify the session ID of the lead, and from the session ID, various pieces of information can be obtained about the lead in advance. Scripts for the telephone call are then generated based on the information obtained about the lead, and then the scripts are provided to an operator at the call center 99, which therefore shortens the conversation between the call center 99 and the lead, thereby providing faster forwarding of the lead to agents or other disposition of the lead.

In an embodiment, the storage device 24 includes one or more databases that stores session IDs and browsing data associated with each consumer. For example, if a consumer navigates through websites/webpages hosted by the third party computing systems 14a-14e, the browsing data associated with this navigation (e.g., which homes were viewed, costs of homes viewed, search criteria entered by the consumer, or other properties of homes that were of interest to the consumer while browsing) is stored in the storage device 24. The data stored in the storage device 24 can then be readily accessed by the tracking computing system 12 according to the session ID, so as to generate an appropriate script for an operator at the call center 99 when the consumer contacts the call center 99 by way of the telephone number and telephone extension number. This process will be described in further detail later below.

The third party computing systems 14a-14e may take the form of a computer 26 configured to function as a server and/or client, and may optionally include a monitor 28, and one or more user input devices such as a keyboard, keypad, mouse, trackball, digitizing tablet 30, and/or touch screen display. Some of the third party computing systems 14a-14c may be communicatively coupled to via a local or a wide area network 32, with access to the Internet 16 provide by a server 34. Such may be operated by or comprise a first third party affiliate with a respective website/webpage A. The third party computing system 14d may be operated or comprises a second third party affiliate with a respective website/webpage B. The third party computing system 14e may be operated by or comprises an originating third party affiliate with a respective website/webpage O. While only five third party computing systems 14a-14e are illustrated, typical environments 10 would provide an almost unlimited number of third party computing systems 15, since almost every business operated computing system in the world having access to the Internet could operate as a third party computing system 14a-14e. The third party computing systems 14a-14e can be operated by real estate companies, for example.

The consumer computing system 15 may take the form of a computer such as a client computer 31, and may optionally include a monitor 33, and one or more user input devices such as a keyboard, keypad, mouse, trackball, digitizing tablet 35, and/or touch screen display. While only a single consumer computing system 15 is illustrated, typical environments 10 would provide an almost unlimited number of consumer computing systems 15, since almost every computing system in the world having access to the Internet could operate as a consumer computing system 15.

In particular FIG. 2 shows a personal computer referred to herein as a computing system 46 that may be appropriately configured to function as either the tracking computing system 12 (FIG. 1), as one of the third party computing systems 14a-14e, or the consumer computing system 15.

The computing system 46 includes a processor unit 48, a system memory 50, and a system bus 52 that couples various system components including the system memory 50 to the processing unit 48. The processing unit 48 may be any logical processing unit, such as one or more central processing units (CPUs), digital signal processors (DSPs), application-specific integrated circuits (ASIC), etc. Unless described otherwise, the construction and operation of the various blocks shown in FIG. 2 are of conventional design. As a result, such blocks need not be described in further detail herein, as they will be understood by those skilled in the relevant art having the benefit of this disclosure.

The system bus 52 can employ any known bus structures or architectures, including a memory bus with memory controller, a peripheral bus, and/or a local bus. The system memory 50 includes read-only memory (ROM) 54 and random access memory (RAM) 56. A basic input/output system (BIOS) 58, which can form part of the ROM 54, contains basic routines that help transfer information between elements within the computing system 46, such as during startup.

The computing system 46 also includes one or more spinning media memories such as a hard disk drive 60 for reading from and writing to a hard disk 61, and an optical disk drive 62 and a magnetic disk drive 64 for reading from and writing to removable optical disks 66 and magnetic disks 68, respectively. The optical disk 66 can be a CD-ROM, while the magnetic disk 68 can be a magnetic floppy disk or diskette. The hard disk drive 60, optical disk drive 62 and magnetic disk drive 64 communicate with the processing unit 48 via the bus 52. The hard disk drive 60, optical disk drive 62 and magnetic disk drive 64 may include interfaces or controllers coupled between such drives and the bus 52, as is known by those skilled in the relevant art, for example via an Integrated Drive Electronics (IDE) interface. The drives 60, 62 and 64, and their associated computer-readable media 61, 66 and 68, provide nonvolatile storage of computer-readable instructions, data structures, program modules and other data for the computing system 46. Although the depicted computing system 46 employs hard disk 61, optical disk 66 and magnetic disk 68, those skilled in the relevant art will appreciate that other types of spinning media memory computer-readable media may be employed, such as, digital video disks (DVD), Bernoulli cartridges, etc. Those skilled in the relevant art will also appreciate that other types of computer-readable media that can store data accessible by a computer may be employed, for example, non-spinning media memories such as magnetic cassettes, flash memory cards, RAMs, ROMs, smart cards, etc.

Program modules can be stored in the system memory 50, such as an operating system 70, one or more application programs 72, other programs or modules 74, and program data 76. The applications programs 72 may include one or more programs for tracking lead origination, locating and/or notifying suitable agents, tracking the status of leads, and maintaining information about agents and other third party affiliates.

The modules 74 of an embodiment include one or more web services. The web services allow the computing system 46 to communicate with other computing systems. For example, web services can be used to communicate session ID information and browsing data between the tracking computing system 12 and the third party computing systems 14a-14e, in a manner that will be described later below. Alternatively or additionally, the modules 74 can comprise suitable elements different than web services that can be used for communicating data between two or more computing systems.

The system memory 50 also includes one or more communications programs 77, which may be the same as or different from the web services described above, for permitting the computing system 46 to access and exchange data with sources such as websites of the Internet, corporate intranets, or other networks, as well as other server applications on server computers. The communications program 77 may take the form of a server program, particularly where the computing system 46 implements the server computer 18 (FIG. 1) or third party computer 26. Alternatively, or additionally, the communications program may take the form of a browser program, particularly where the computing system 46 implements the consumer computer 31 (FIG. 1). The communications program 77 may be markup language based, such as hypertext markup language (HTML), and operate with markup languages that use syntactically delimited characters added to the data of a document to represent the structure of the document.

While shown in FIG. 2 as being stored in the system memory 50, the operating system 70, application programs 72, other program modules 74, program data 76 and communications program 77 can be stored on the hard disk 61 of the hard disk drive 60, the optical disk 66 and the optical disk drive 62 and/or the magnetic disk 68 of the magnetic disk drive 64.

A user can enter commands and information to the computing system 46 through input devices such as a keyboard 78 and a pointing device such as a mouse 80. Other input devices can include a microphone, joystick, game pad, scanner, etc. These and other input devices are connected to the processing unit 48 through an interface 82 such as a serial port interface that couples to the bus 52, although other interfaces such as a parallel port, a game port or a universal serial bus (USB) can be used. A monitor 84 or other display devices may be coupled to the bus 52 via video interface 86, such as a video adapter. The computing system 46 can include other output devices such as speakers, printers, etc.

The computing system 46 can operate in a networked environment 10 (FIG. 1) using logical connections to one or more remote computers. The computing system 46 may employ any known means of communications, such as through a local area network (LAN) 88 or a wide area network (WAN) or the Internet 90. Such networking environments are well known in enterprise-wide computer networks, intranets, extranets, and the Internet.

When used in a LAN networking environment, the computing system 46 is connected to the LAN 88 through an adapter or network interface 92 (communicatively linked to the bus 52). When used in a WAN networking environment, the computing system 46 often includes a modem 93 or other device for establishing communications over the WAN/Internet 90. The modem 93 is shown in FIG. 2 as communicatively linked between the interface 82 and the WAN/Internet 90. In a networked environment, program modules, application programs, or data, or portions thereof, can be stored in a server computer (not shown). Those skilled in the relevant art will readily recognize that the network connections shown in FIG. 2 are only some examples of establishing communication links between computers, and other communications links may be used, including wireless links.

The computing system 46 may include one or more interfaces such as slot 94 to allow the addition of devices 96, 98 either internally or externally to the computing system 46. For example, suitable interfaces may include ISA (i.e., Industry Standard Architecture), IDE, PCI (i.e., Personal Computer Interface) and/or AGP (i.e., Advance Graphics Processor) slot connectors for option cards, serial and/or parallel ports, USB ports (i.e., Universal Serial Bus), audio input/output (i.e., I/O) and MIDI/joystick connectors, and/or slots for memory.

The term “computer-readable medium” as used herein refers to any medium that participates in providing instructions to processor unit 48 for execution. Such a medium may take many forms, including but not limited to, non-volatile media, volatile media, and transmission media. Non-volatile media includes, for example, hard, optical or magnetic disks 61, 66, 68, respectively. Volatile media includes dynamic memory, such as system memory 50. Transmission media includes coaxial cables, copper wire and fiber optics, including the wires that comprise system bus 52. Transmission media can also take the form of acoustic or light waves, such as those generated during radio wave and infrared data communications.

Common forms of computer-readable media include, for example, floppy disk, flexible disk, hard disk, magnetic tape, or any other magnetic medium, CD-ROM, any other optical medium, punch cards, paper tape, any other physical medium with patterns of holes, RAM, PROM, EPROM, EEPROM, FLASH memory, any other memory chip or cartridge, a carrier wave as described hereinafter, or any other medium from which a computer can read.

Various forms of computer readable media may be involved in carrying one or more sequences of one or more instructions to processor unit 48 for execution. For example, the instructions may initially be carried on a magnetic disk of a remote computer. The remote computer can load the instructions into its dynamic memory and send the instructions over a telephone line using a modem. A modem 93 local to computer system 46 can receive the data on the telephone line and use an infrared transmitter to convert the data to an infrared signal. An infrared detector coupled to the system bus 52 can receive the data carried in the infrared signal and place the data on system bus 52. The system bus 52 carries the data to system memory 50, from which processor unit 48 retrieves and executes the instructions. The instructions received by system memory 50 may optionally be stored on storage device either before or after execution by processor unit 48.

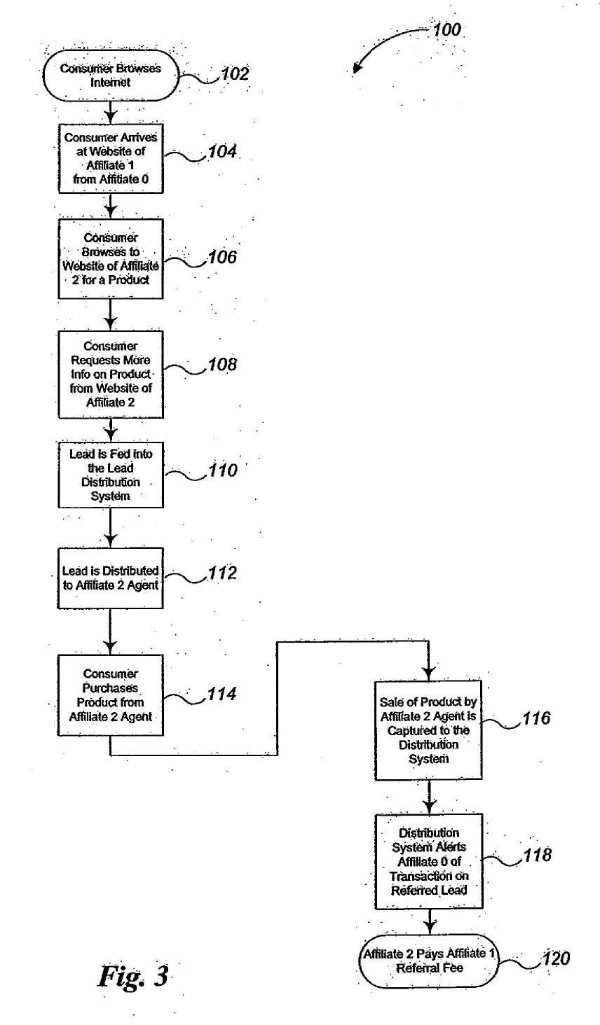

FIG. 3 is a flow diagram of a high level method 100 according to one illustrated embodiment.

At 102, a consumer browses the Internet, perhaps looking to purchase a product (e.g., a good or service), perhaps looking for some piece of information, or perhaps simply passing time. At 104, the consumer arrives at a website/webpage A of a first third party affiliate. The consumer may arrive at the website/webpage A from a previous website/webpage O operated by an originating third party affiliate that has invested in advertising their webpage or website O or that has other goodwill that initially attracted the consumer.

In an embodiment, the consumer may also arrive at the website/webpage A by way of an entry point website/webpage hosted by the entity that operates the tracking computer system 12 or by some other suitable entity. The consumer can reach the website/webpage A through a single instance of a browser that presents the entry point website/webpage, or the consumer can reach the website/webpage A through additional instance(s) of a browser after the consumer has initially accessed the entry point website/webpage.

The tracking computing system 12 causes a unique session identifier (ID) of the consumer browser session to be saved for later use, for example, in the database of data storage device 24 or as a cookie on the consumer's computing system 15 or the third party affiliate's computing system 14a-14e. In an embodiment, a session ID may be saved and associated with the browsing session when the consumer first accesses the entry point website/webpage and/or a different session ID may be saved and associated with the browsing session as the consumer navigates through each third party affiliate's website/webpage.

Storing the unique session ID at the data storage device 24 allows the subsequent browsing data associated with the session ID to be accessed by the tracking computing system 12 (and/or by the call center 99 in another embodiment). Storing the unique session identifier at the database of data storage device 24 also provides an enhanced level of security over the other options. In some embodiments, storing the unique session identifier on the third party affiliate's computing system 14a-14e, or even on the consumer's computing system 15, reduces the amount of network traffic and allows the entity operating the tracking computing system 12 to offload the storage function.

The consumer may browse through the website or webpages of the first third party affiliate at 104, searching for homes of interest, for instance. At 106, the consumer continues browsing and may reach a website/webpage B operated by a second third party affiliate. The consumer may locate a good and/or service offered on the website/webpage B, for which the third party affiliate is a specialist in providing or which is competitively priced or has other desirable qualities. The browser session is automatically changed to website/webpage B, thus the consumer may, or may not, notice the change from website/webpage A to website/webpage B. This transfer of websites/webpages constitutes an “event” which is managed and tracked by the tracking computing system 12 and/or third party affiliate computing system 14a-14e within this example. This event is saved for later use, for example in the database of data storage device 24 or as a cookie on the consumer's computing system 15 or the third party affiliate's computing system 14a-14e.

In an embodiment, the event can be associated with a new session ID that corresponds to the browsing session on website/webpage B or on any other new website/webpage. Alternatively or additionally, the same session ID can be used as the consumer navigates from one third party affiliate website/webpage to another. Still alternatively or additionally, different session IDs may be used and suitably associated with one another so that the tracking computing system 12 can identify the browsing as being associated with the same session and/or consumer. The same instance of the browser or different instances of the browser can be presented to the consumer, as the consumer navigates from one third party affiliate website/webpage to another.

At 108, the consumer requests more information, for example, via email, online form, chat request, or a telephone call. The request includes the capture by the tracking computing system 12 of the unique browser session identifier stored at 104, which in one embodiment involves associating a telephone extension number with the session ID. This unique browser session identifier links the online session and the tracked events resulting from it to this request. This linking may be accomplished whether the request by the consumer is an online request or an offline request (e.g., via a telephone call). At this point all tracked browser history is available for reporting as desired. The tracking computing system 12 may also capture additional information, such as contact information for the consumer, which can be used below at 110 to link those steps back to the unique browser session identifier.

At 110, the captured lead is fed by the by the tracking computer system 12 into a lead distribution system via any number of means of communications means, for example, broadcasting or point casting using various communications channels such as wired or wireless communications including but not limited to email, telephone calls and/or messages, pager, and/or instant text messaging.

At 112, the lead is distributed to the available agent having criteria that best matches selected criteria as determined by the distribution process. As discussed in more detail below, the agent is selected by one or more criteria specified by the referring third party affiliate (originating and/or intervening third party affiliate), the entity for which the agent works, the entity providing the tracking service, and/or consumer. Consequently, the best matching agent is selected to assist the consumer with the request for more information, based on the details of the lead. In one embodiment, the tracking computing system 12 distributes the lead to the lead distribution system.

At 114, the consumer purchases product and/or service from Website/Webpage B associated with the second third party affiliate. The consumer may make the purchase in a conventional manner, for example, by entering requested data and making the desired selections typical of checkout procedures commonly encountered on retail Websites/Webpages.

At 116, the Website/Webpage B reports the sale to the tracking computing system 12, providing any one of the unique identifying data elements previously gathered, for example at 104 or 108. In this example those elements are either the unique browser session identifier and/or the additional information provided by the consumer at 108.

At 118, the tracking computing system 12 determines that the originating third party affiliate operating the Website/Webpage O was the originator of the lead (lead originator) and second third party affiliate operating the Website/Webpage B was the product/service provider. The tracking computing system 12 alerts the originating third party affiliate operating the Website/Webpage O of the results of the lead follow-up. Optionally, the tracking computing system 12 may alert intervening third party affiliates, for example the first third party affiliate operating the Website/Webpage A of the results of the lead follow-up, particular where compensation and/or award will be provided to one or more intervening third party affiliates.

The example provided above at 118 is merely illustrative of one possible implementation for tracking and notification. Other embodiments can use different implementations at 118. Because tracking and notification at 118 is outside the scope of the present disclosure, details of such other embodiments are not provided herein for the sake of brevity.

At 120, the provider of the tracking services or other entity distributes a fee or other award to the originating third party affiliate operating Website/Webpage O, as compensation or acknowledgement for attracting consumer into the affiliated network via the Website/Webpage O. The provider of the tracking services or other entity may pay the fee or make the award from compensation provided by the second third party affiliate operating the Website/Webpage B in response to making the sale. Alternatively, the provider of the tracking services or other entity may pay the fee or make the award from compensation received from a participation fee paid by the second third party affiliate for participating in the third party affiliate network. While the provider of the tracking services has generally been discussed as a separate entity from the third party affiliates, such should not be considered limiting. In this sense, it is understood that the provider of the tracking services may also be one of the third party affiliates participating in the third party affiliation network. Additionally, the operators of intervening Websites/Webpages may also receive compensation and/or awards.

Details of example embodiments involving the operations at 110-120 (as well as details of other operations and features) are disclosed in co-pending U.S. patent application Ser. No. 11/027,762, entitled “METHOD, APPARATUS AND ARTICLE FOR TRACKING AND/OR REWARDING THIRD PARTIES WITHIN A NETWORKED COMMERCIAL ENVIRONMENT,” filed Dec. 30, 2004, assigned to the same assignee as the present application, and incorporated herein by reference in its entirety. For the sake of brevity, such details will not be repeated herein.

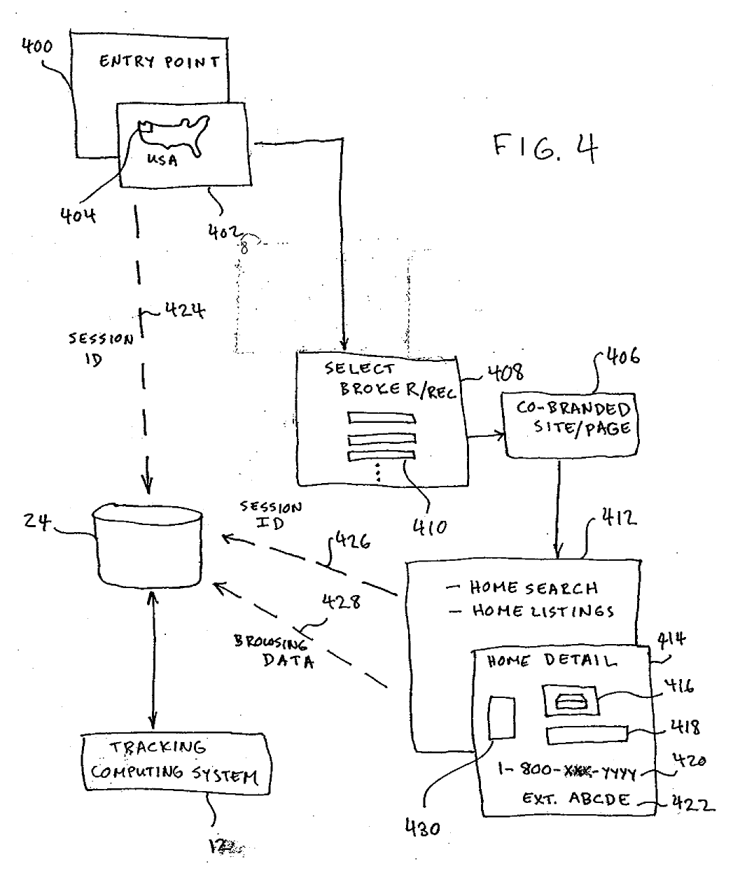

FIG. 4 shows navigation through various example websites/webpages according to an embodiment. More particularly, FIG. 4 illustrates a manner in which one or more session IDs and related browsing data can be associated with a telephone extension number (or representation thereof). The example navigation illustrated in FIG. 4 can occur at 104-108 of FIG. 3, for example.

The navigation begins when a consumer accesses an entry point website/webpage 400. The entry point website/webpage can be operated by the entity that operates the tracking computing system 12, the call center 99, or by some other entity that may have relationships with the third party computing systems 14a-14e, which may be operated by real estate companies, for example.

At the entry point website/webpage 400, the consumer is presented with a webpage 402 on the browser of the consumer computing system 15. The webpage 402 may present, for instance, a representation of a geographical region (such as a map of the United States) from which the consumer can select a particular sub-region 404 of interest (such as a particular state). Other implementations may allow the consumer to bypass a map search and instead perform searching using other criteria (e.g., zip code, city and state, type of home, etc.).

In an embodiment, a first session ID is assigned to the consumer when the consumer accesses the entry point website/webpage 400 and/or when the consumer accesses any of its underlying webpages. The session ID can be assigned by the server 18, for example, and is stored at 424 in the data storage device 24. This session ID serves to identify the current browsing session of the consumer.

When the consumer selects the sub-region 404, the consumer's browser is taken to a webpage 408 that corresponds to the sub-region 404. According to an embodiment, the consumer can select a particular real estate company (REC) 410 (or real estate broker or other available choices) from the webpage 408. Selection of a particular REC 410 from the webpage 408 will instantiate a co-branded website/webpage 406 that corresponds to the selected REC 410.

The co-branded website/webpage 406 can be shared, for example, between the entity that owns or operates the entry point website/webpage 400 and one or more of the entities that own or operate the third party computing systems 14

a-14e, such as the selected real estate company 410. Alternatively or additionally in other embodiments, the website/webpage 406 need not necessarily be co-branded or otherwise shared between such entities.

One technique to take the consumer from the webpage 408 to the co-branded website/webpage 406 is to launch a new instance of a browser that renders the co-branded website/webpage 406. Another technique is to switch from one website/webpage to another website/webpage within the same browser.

From the co-branded website/webpage 406, the consumer can access a website/webpage 412. The website/webpage 412 of an embodiment is operated or owned by the selected REC 410 and/or comprises part of the co-branded website/webpage 406. Again, the website/webpage 412 can be provided by way of a new instance of a browser or through an existing instance of a browser

Upon navigation to this website/webpage 412, an embodiment stores, at 426 in the data storage device 24, a second session ID associated with accessing and browsing the website/webpage 412. The second session ID at 426 may be the same or different than the first session ID at 424. These two session IDs are suitably linked with one another in the data storage device 24 such that they can be identified as belonging to the same browsing session.

At the website/webpage 412 of the selected REC 10, the consumer can peruse listings of homes of interest (such as by navigating through home listings having a certain price range, number of bedrooms, geographic location, or other attributes) and/or the consumer can perform search queries for homes of interest that have certain attributes. If the consumer chooses to view additional details pertaining to a specific home, then further details of that home are rendered by the browser in a webpage 414. The webpage 414 can present, for instance, a picture 416 of the home and a description 418 (e.g., price range, color, square feet, number of bedrooms, and other attributes).

According to an embodiment, the webpage 414 also presents a telephone number 420. The telephone number 420 can be a toll-free 800 number or other suitable one or more telephone numbers that may be maintained by the call center 99 for the selected REC 410. A different telephone number 420 can be maintained by the call center 99 for each REC, for various offices or entities associated with an REC, or other suitable assignment of telephone numbers.

The browsing data, including attributes associated with homes or other information viewed and/or accessed by the consumer from the website/webpage 412, are stored in the data storage device 24 at 428. Accordingly, useful data associated with the browsing session can be saved and later used when following up with the consumer.

In an embodiment, the displayed telephone number 420 includes a displayed telephone extension number 422. The displayed telephone extension number appears to the consumer as a normal telephone extension number, but in an embodiment actually represents a session ID associated with the current browsing session. The displayed telephone extension number 422 can represent, for example, the underlying first and/or second session IDs described above. Any suitable technique can be used to generate the telephone extension number 422. For instance, the call center 99 can assign a telephone extension number to the current browsing session, and then communicate the telephone extension number to a server 34 of the selected REC 10, so that the telephone extension number is rendered on the webpage 414.

In operation, the consumer (if interested in the home displayed on the webpage 414), dials the telephone number 420 to obtain more information about the home, including trying to get in contact with an agent that is selling the home. The consumer reaches the call center 99 by dialing the telephone number and provides the extension number 422 associated with that home or property as an example. At the call center 99, an operator in one embodiment is provided with the extension number 422 by the consumer and inputs the extension number 422 into the tracking computing system 12. Based on extension number 422, the tracking computing system 12 performs lookups (such as database lookups of session IDs) into the data storage device 24 to obtain the corresponding consumer data (such as browsing data that was captured), and carefully crafts scripts that are then provided to the operator.

The operator follows the scripts to get additional information from the customer, after which the lead is either closed or distributed by the lead distribution system. For example, if the operator engages in a telephonic dialog with the consumer using the scripts, the operator can obtain additional information from the consumer that may not have been captured by the browsing data. Based on the responses to the scripts that are provided by the consumer to the operator, the tracking computing system 12 can determine what to do with the consumer inquiry. The tracking computing system 12 can, for instance, broadcast the consumer's inquiry (e.g., lead) into the distribution system according to 110-120 in FIG. 3 to locate a suitable agent that can follow up on the lead. Alternatively, the tracking computing system 12 may be able to determine that the lead is not likely to result in a sale (e.g., a basic consumer question), and therefore, the tracking computing system 12 can refer the consumer to the REC 10 to have the question answered.

As is evident by the description of the above embodiment(s), the interaction between the call center 99 and the consumer can be shorter and more efficient. The consumer does not need to resupply information that was previously supplied through the various websites/webpages, and the tracking computing system 12 can readily determine which home(s) is the subject of the customer's inquiries and can also determine some information about the consumer (e.g., demographic information, price preferences, style preferences, or other consumer data that pertain to attributes of potential homes of interest). Based on all of this information, the tracking computing system 12 can tailor a script to be used by the operator during the conversation with the consumer, and based on responses provided by the consumer to the operator, readily decide the next action to take for the consumer inquiry. In one embodiment, the scripts can be generated dynamically in sequence based on information received by the operator from the consumer, using branching and other logical decisions based on answers to prior scripts. For instance, a first script may direct the operator to ask the consumer a first question. Based on the answer to the first question, the tracking computing system 12 can generate a second script to direct the operator to ask the consumer a second question. Based on the answer to the second question, the tracking computing system 12 can generate a third script, and so on until a point is reached where the tracking computer system 12 provides a decision to the operator as to how to handle the customer inquiry. For example, the tracking computer system 12 can direct the operator to feed the lead into the lead distribution system and inform the consumer that an agent “will call you back in 30 minutes.” Another possible disposition is to direct the consumer to a customer service representative of the selected REC 410 or other option to handle trivial questions or inquiries. Other dispositions of the consumer inquiry are possible after the operator has finished obtaining information from the consumer using the scripts.

In one embodiment, the consumer can fill out an online form 430 located on the webpage 414 or at any other suitable location on the website/webpage 412. The consumer can enter, for example, their name, address, contact information, desired attributes of homes of interest, or other information. The consumer can also specify whether they wish to be contacted by an agent by way of telephone, email, fax, etc. and at which days/times. The information entered by the consumer on the form 430 is delivered to the data storage device 24, as well as browsing data and session ID(s), for storage and subsequent use.

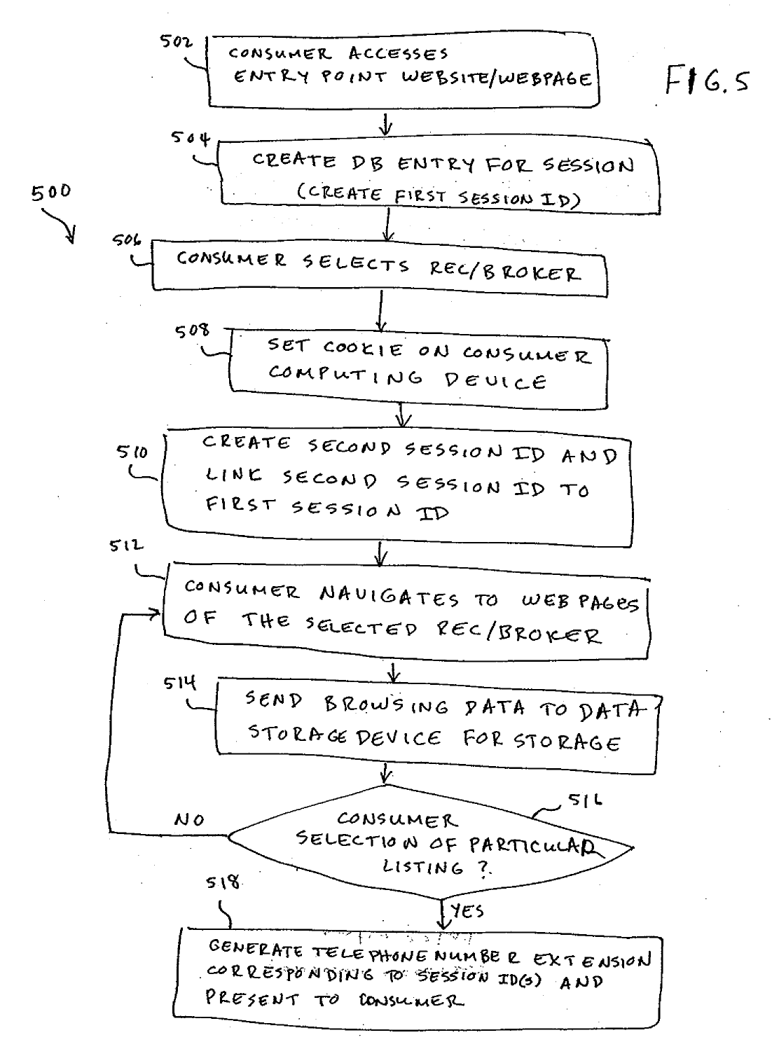

FIG. 5 is a flowchart of an embodiment of a method 500 to associate a telephone extension number to one or more session IDs, including storage of browsing data related to the session ID. In one embodiment, at least some of the operations depicted in the method 500 can be implemented by software or other machine-readable instructions stored on a machine-readable medium and executable by a processor. For instance, such operations can be embodied in server software executed by a processor. The operations depicted in the method 500 need not necessarily occur in the exact order shown, and operations can be suitably added, removed, modified, and/or combined in other embodiments. Similarly, in some embodiments, the various operations depicted in the other flow diagrams shown and described herein may also be implemented by software or other machine-readable instructions stored on a machine-readable medium and executable by one or more processors.

At a block 502, the consumer accesses the entry point website/webpage 400, such as by navigating the consumer's browser to a URL address of the website/webpage 400. The consumer may also instead access some other initial website/webpage at the block 502, such as a website/webpage of a third party affiliate.

At a block 504, an entry is created (such as a database entry) in the data storage device 24 for the browsing session that has now begun when the consumer accessed the entry point website/webpage 400. In one embodiment, creation of the database entry at the block 504 comprises creation of a first session ID by the server 18 of the tracking computing system 12.

At a block 506, the consumer selects a REC/broker. This selection can be performed at the entry point website/webpage 400 or at the co-branded website/webpage 406. If the consumer's browser is directed from the entry point website/webpage 400 to the co-branded website/webpage 406 during the process of making this selection, then a switch from the server 18 to a subsequent server may be involved. The switch from the server 18 to the subsequent server may involve generation of an intermediate session ID by the subsequent server. Therefore, the intermediate session ID is linked or otherwise associated with the first session ID in the data storage device so that the tracking computing system 12 knows that both session IDs belong to the same browsing session. The intermediate session ID may or may not be the same as the first session ID, and can be generated by the subsequent server that hosts the co-branded website/webpage 406 and communicated to the server 18 for storage in the data storage device 24 by way of a web service or other suitable technique to communicate between network devices.

At a block 508, a cookie may be set on the consumer computing device 15. The cookie operates to associate the particular consumer computing device 15 to the session ID(s) that have been generated and also to help track the browsing history of the consumer computing device 15.

At a block 510, the consumer has selected a particular REC/broker, and the consumer's browser has been directed to the website/webpage 412 of the selected REC/broker. This navigation to the website/webpage 412 may involve a re-direction to yet another server (such as the server 34), thereby resulting in generation of a second session ID by the server 34. The second session ID may or may not be the same as the first session ID generated by the server 18 of the tracking computing system 12.

In an embodiment, the server 18 can pass the first session ID to the server 34 at the block 510 so that both servers can associate the two session IDs (and consequently the same browsing session) to one another. Alternatively in another embodiment, the server 34 can pass the second session ID to the server 18 (perhaps involving intermediate hops through other servers in the network) at the block 510, so that the server 18 can associate the second session ID with the first session ID.

At a block 512, the consumer navigates through the various webpages in the website/webpage 412 of the selected REC/broker. For example, the consumer can peruse home listings, perform searches, fill out on-line forms 424, and so forth at the block 512.

At a block 514, the server 34 sends browsing data back to the server 18 for storage in the data storage device 24 as the consumer navigates through the various webpages during the browsing session. As with the communication of session IDs between servers, the communication of browsing data at the block 514 can be performed by a web service or other suitable communication technique between network devices. In one embodiment, the server 34 parses the URLs and/or other information associated with the browsing session, so that the server 18 receives the relevant browsing data. In another embodiment, the server 34 sends un-parsed URLs and/or other information associated with the browsing session to the server 18, and then the server 18 performs the appropriate parsing to obtain the relevant browsing data. Browsing data is sent back to the server 18 each time the consumer navigates to a different webpage or fills out an on-line form 430, for instance.

At a block 516, the consumer may select a particular home listing in order to view additional details on the webpage 414. When this selection is made, the server 34 notifies the server 18, such as by sending the browsing data having a URL of the webpage 414. Upon detection of the URL of the webpage 414, the server 18 generates the telephone extension 422 number at a block 518, places the generated telephone extension number in the data storage device 24, and links the generated telephone extension number to the corresponding first session ID. The server 18 also communicates the telephone extension number to the server 34, so that the server 34 can render the telephone extension number 422 on the webpage 414.

In other embodiments, the server 34 can generate and present the telephone extension number 422, and then communicate the generated telephone extension number 422 back to the server 18. Various techniques can be used in embodiments to generate, store, and present the telephone extension number 422.

Thereafter, the consumer can choose to dial the telephone number 420 and the telephone extension number 422, which results in a connection to the call center 99. Upon receiving the telephone call that specifies or otherwise provides the telephone extension number 422, an operator at the call center 99 can input the telephone extension number 422 to receive a script that corresponds to the consumer and which has been tailored based on data that has been gathered about the consumer. The operator uses the script to obtain additional information from the consumer, which is fed back into the tracking computing system 12 to allow the tracking computing system 12 to decide a next course of action for the consumer inquiry.

In an alternative embodiment, the operator can retrieve and review the associated browsing data in the data storage device 24 using the telephone extension number provided by the consumer, and thus readily address the consumer's telephone inquiry. Making the browsing data readily available to the operator allows the interaction with the consumer to happen quicker and more efficiently, thereby allowing the operator to feed the lead into the lead distribution system and/or otherwise dispose of the consumer's inquiry.

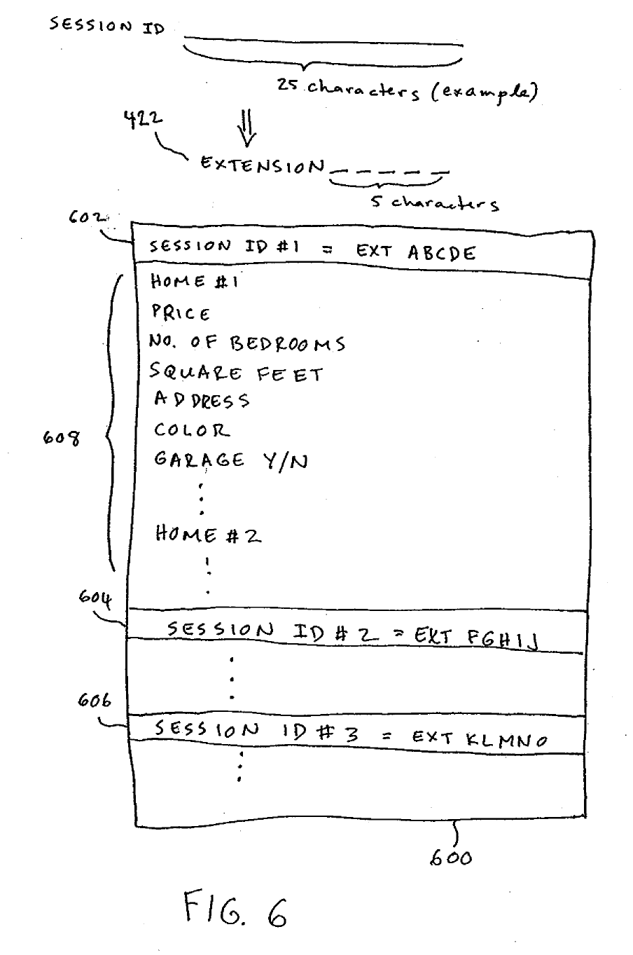

FIG. 6 shows a representation of an embodiment of database entries 600 according to an embodiment, including association of a session ID with a telephone extension number 422. In one embodiment, an example session ID comprises 25 characters. Therefore, a large number of distinctive session IDs can be generated for many consumers for their respective browsing sessions.

The various telephone extension numbers 422 that are respectively associated with each session ID comprises string having up to five characters, such as five numerical characters. Using up to five characters is advantageous in certain respects. First, a string having five numbers or less looks like a realistic telephone extension number to a consumer. If the telephone extension number 422 is too long, then it does not look realistic and a consumer may be reluctant to dial, write down, or otherwise provide that many numbers. Secondly, a string having up to five characters allows the telephone extension numbers to be reused for other subsequent browsing sessions and/or consumers without undue duplication. Conversely, a string having less than five numbers/characters will have more duplication as the number of browsing sessions and/or consumers increase.

The database entries 600 of FIG. 6 can be stored in the data storage device 24, such as in the form of tables, fields, or other suitable data structure. Different session IDs (such as for different browsing sessions by the same or different consumers) are stored at entries 602, 604, and 606, and a unique telephone extension number is associated with each session ID for any particular entity and/or any particular time.

Under each session ID, browsing data 608 is stored. The browsing data can include, for example price, number of bedrooms, square feet, address, color, garage (yes/no), MLS number, number of bathrooms, URL, or other attributes associated with a home. Each home listed under each session ID can have their own associated browsing data, which was captured by the server 34 and sent back to the server 18.

The various database entries 600 can be static or dynamic. For example, browsing data can be dynamically stored as the browsing data is received. In contrast, the session IDs can be more static, as such session IDs can remain persistent at least throughout the browsing session of the consumer.

The above description of illustrated embodiments, including what is described in the Abstract, is not intended to be exhaustive or to limit the invention to the precise forms disclosed. Although specific embodiments of and examples are described herein for illustrative purposes, various equivalent modifications can be made without departing from the spirit and scope of the invention. The teachings provided herein by the embodiments can be applied to other methods, systems and articles that do not necessarily and directly involve the purchasing of a home. For example, telephone extension numbers associated with a session ID can be used for tracking and processing a consumer's inquiries for home services, bank loans, search for amenities, and so forth.

Moreover, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). Also the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to U.S. Provisional Patent Application Ser. No. 60/533,306, filed Dec. 30, 2003 are incorporated herein by reference, in their entirety. Also incorporated by reference in its entirety is U.S. Provisional Patent Application Ser. No. 60/695,839, entitled “TECHNIQUE IN A NETWORKED ENVIRONMENT FOR OPTIMALLY MATCHING CONSUMERS AND AGENTS FOR A COMMERCIAL TRANSACTION, SUCH AS A REAL ESTATE TRANSACTION,” filed June 30, 2005, which describes example matching techniques and systems that can be implemented by the various embodiments. Aspects of the embodiments can be modified, if necessary, to employ systems, circuits and concepts of the various patents, applications and publications to provide yet further embodiments.

For example, various embodiments have been described herein in the context of a consumer's navigation through websites/webpages in order to find a home to purchase. Other embodiments can be provided for consumers that navigate through websites/webpages in order to sell a home and/or to find an agent to sell a home. These are but two possible examples in which a telephone extension number can be used to identify a browsing session.

In one embodiment, the consumer is presented with a telephone number and telephone extension number. The consumer can dial the telephone number to reach an operator of the call center 99 and then orally provide the telephone extension number to the operator to allow the operator to access the corresponding script. In another embodiment, the consumer can dial both the telephone number and telephone extension number, so that the corresponding script can be obtained automatically by the call center 99 prior to when the consumer and operator speak in real time.

In various embodiments described above, the call center 99 has a generally limited role of providing input information into the tracking computing system 12 and conducting a dialog with the consumer based on a tailored script provided by the tracking computing system 12. In another embodiment, operators at the call center 99 can perform more active roles, including performing lookups into databases, answering consumer inquiries, deciding a next course of action for the lead, and so forth. In yet another embodiment, the tracking computing system 12 and the call center 99 are not separate and instead can be integrated as the same system.

These and other changes can be made to the embodiments in light of the above-detailed description. In general, in the following claims, the terms used should not be construed to limit the invention to the specific embodiments disclosed in the specification and the claims. Accordingly, the invention is not limited by the disclosure, but instead its scope is to be determined entirely by the following claims, which are to be construed in accordance with established doctrines of patent claim interpretation.

What is claimed is:

1. A method for a computer network, the method comprising:
assigning a session identifier (ID) to a browsing session of a consumer of real estate;
storing browsing data associated with the browsing session of the consumer;
associating the session ID with a representation of a telephone extension number that is presented to the consumer; and
retrieving at least some of the stored browsing data in response to use of the telephone extension number by the consumer.

2. The method of claim 1 wherein the browsing session of the consumer involves navigation to a plurality of servers, each server being associated with a respective session ID, the method further comprising linking the respective session IDs to the assigned session ID in a manner that identifies such session IDs as belonging to a same browsing session.

3. The method of claim 1 wherein the representation of the telephone extension number comprises a string of up to five characters.

4. The method of claim 1, further comprising:
providing the consumer with access to an entry point website/webpage;
in response to consumer input, directing the consumer from the entry point website/webpage to an intermediate website/webpage from which the consumer can select from a plurality of available choices;
in response to consumer selection of one of the available choices, providing the consumer with access to a website/webpage corresponding to the selected choice; and
in response to consumer request for additional information from the website/webpage corresponding to the selected choice, presenting the requested additional information along with the representation of the telephone extension number.

5. The method of claim 4 wherein the available choices include available real estate brokers, and wherein the intermediate website/webpage comprises a website/webpage that is co-branded between an entity that operates the entry point website/webpage and at least one of the available real estate brokers.

6. The method of claim 4 wherein each website/webpage is associated with a respective session ID, wherein at least some of the session IDs may be a same session ID, the method further comprising linking the respective session IDs to the assigned session ID in a manner that identifies such session IDs as belonging to a same browsing session.

7. The method of claim 1, further comprising generating the telephone extension number and communicating the generated telephone extension number to a server that can generate the representation of the telephone extension number for presentation to the consumer.

8. The method of claim 1 wherein storing the browsing data includes receiving the browsing data from at least one server that is accessed during the browsing session and storing the received browsing data in a database

9. A system to facilitate distribution of leads, the system comprising:
at least one processor to generate a telephone extension number associated with a respective browsing session;
at least one data storage device coupled to the processor to store browsing data and a session ID related to the respective browsing session, the session ID being associated with the telephone extension number; and
a tracking computing system having access to the storage device, wherein the telephone extension number can be presented to a consumer and if used, allows the tracking computing system to identify the associated session ID and related browsing data to facilitate interaction with the consumer.

10. The system of claim 9, further comprising a module coupled to the data storage device to request and receive the browsing data from a network location that has been accessed during the browsing session, and to further store the received browsing data in the data storage device.

11. The system of claim 9, further comprising a website/webpage that is shared between a first entity that operates the tracking computing system and a second entity that provides goods/services being sought by the consumer.

12. The system of claim 9 wherein the data storage device comprises a database having entries for session IDs corresponding to browsing data, the browsing data entries being dynamically stored in the database as the browsing data is received, the session ID entries being persistent at least throughout their corresponding browsing session.

13. The system of claim 9 wherein the telephone extension number is represented by a string of up to five characters.

14. The system of claim 9 wherein the tracking computing system facilitates interaction with the consumer by using the browsing data to generate a script usable by a call center to obtain additional information about an inquiry of the consumer that allows the tracking computing system to direct the inquiry of the consumer to a lead distribution system.

15. An article of manufacture, comprising:
a machine-readable medium usable by a tracking computing system in a computer network and having processor-executable instructions stored thereon to:
assign a session identifier (ID) to a browsing session of a consumer of real estate;
store browsing data associated with the browsing session of the consumer;
associate the session ID with a representation of a telephone extension number that is presented to the consumer; and
retrieve at least some of the stored browsing data in response to use of the telephone extension number by the consumer.

16. The article of manufacture of claim 15 wherein the browsing session of the consumer involves navigation to a plurality of servers, each server being associated with a respective session ID, the machine-readable medium further including instructions stored thereon to link the respective session IDs to the assigned session ID in a manner that identifies such session IDs as belonging to a same browsing session.

17. The article of manufacture of claim 15 wherein the machine-readable medium further includes instructions stored thereon to generate a telephone extension number corresponding to a respective session ID in response to a request for additional information from the consumer.

18. The article of manufacture of claim 15 wherein the machine-readable medium further includes instructions stored thereon to exchange session ID information and related browsing data with at least one external server that is accessed during the browsing session, the external server belonging to an entity that is different from an entity that operates the call center.

19. The article of manufacture of claim 15 wherein the instructions to store the browsing data include instructions to dynamically store the browsing data in a database as the browsing data is received from an external server, different browsing data being associated with different home information that is viewed by the consumer, each session ID being associated with a plurality of different home information viewed by the consumer during the browsing session.

20. The article of manufacture of claim 15 wherein the telephone extension number is presented along with a telephone number of a call center on a webpage that is being browsed by the consumer.

21. A system for a computer network, the system comprising:
means for providing a session identifier (ID) for a browsing session of a consumer of real estate;
means for providing browsing data associated with the browsing session of the consumer;
means for providing a representation of a telephone extension number that is presented to the consumer, the representation of the telephone number being associated with the session ID; and
means for interacting with the consumer based at least in part on some of the browsing data, in response to use of the telephone extension number by the consumer.

22. The system of claim 21 wherein the means for providing the telephone number extension includes a browser means for rendering the telephone number extension.

23. The system of claim 21 wherein the means for interacting with the consumer includes a means for allowing the consumer to decide a mode of communication to use for the interaction.
